(19) United States
(12) Patent Application Publication
(10) Pub. No.: US 2015/0058134 A1
(43) Pub. Date: Feb. 26, 2015

(54) SYSTEMS, METHODS, AND ARTICLES OF MANUFACTURE FOR TARGETED MARKETING VIA IMPROVED CARD EMBOSSING

(71) Applicant: Capital One Financial Corporation, McLean, VA (US)

(72) Inventors: Amanda Y. Hwang, West Linn, OR (US); William Joseph Carina, Poway, CA (US)

(21) Appl. No.: 14/458,940

(22) Filed: Aug. 13, 2014

Related U.S. Application Data
(60) Provisional application No. 61/869,503, filed on Aug. 23, 2013.

(51) Int. Cl. G06Q 30/02; G06Q 20/34; G06K 19/06

(52) U.S. Cl. CPC G06Q 30/0269; G06K 19/06187; G06Q 20/34
USPC 705/14.66; 235/493

(57) ABSTRACT

Systems, methods, and articles of manufacture are disclosed for generating marketing targeted to individual cardholders of shared credit card accounts. A financial service provider may configure a credit card account to be shared by two or more cardholders. The credit card provided to each particular cardholder is embossed with identifying information unique to that individual. The financial service provider reviews purchase transactions associated with the credit card account, and determines the transactions associated with each particular cardholder on the shared account based on the embossed information. Targeted marketing is generated and provided to the particular cardholder based on the purchase transaction information specific to that cardholder.

### CROSS-REFERENCE TO RELATED APPLICATIONS

This application claims priority under 35 U.S.C. §119 to U.S. Provisional Application No. 61/869,503, filed Aug. 23, 2013, which is expressly incorporated herein by reference in its entirety.

### FIELD

The disclosed embodiments generally relate to analyzing and predicting customer purchasing behavior, particularly providing information to retailers about the purchasing behavior of individual customers sharing the same credit card account.

### BACKGROUND

One of the best ways for a retailer to increase sales is to learn more about its customer base and offer better-suited products and incentives to them. As credit cards, debit cards, and other forms of electronic payment have become ubiquitous in modern commerce, it has become easier to log customer purchasing behavior and use it in later marketing efforts.

Many current methods for linking credit card purchases to cardholders, however, do not provide the depth of information that retailers and advertisers desire. Credit cards are embossed and issued under a variety of frameworks and setup parameters, sometimes referred to as “card schemes.” In what is often phrased as a “card centric” system, every individual credit card may bear a unique primary account number, and each individual card is personal to the cardholder. In these situations, individual customer purchasing behavior can be easily traced. An “account-centric” system, however, is far more prevalent in the industry. Under this framework, multiple users, such as family members, co-workers issued a corporate card, etc. may all share a single primary account number. In this circumstance, it becomes impossible to determine which individual cardholder on a shared account completed a particular purchase transaction. Thus, the wealth of information and competitive advantage possible from analyzing individual customer purchasing behavior is lacking in shared accounts, such as credit card accounts employing the “account-centric” system.

Accordingly, there is a need to provide trackable customer purchasing data for credit card accounts in which multiple individual cardholders share a common primary account number.

### SUMMARY

Methods, systems, and articles of manufacture described herein enable a computing system to provide information to retailers about the purchasing behavior of individual cardholders sharing the same credit card account. In one embodiment, a computing system may configure a shared credit card account associated with a financial service provider for shared use by a plurality of cardholders, the credit card account including a plurality of credit cards sharing the same primary account number but each being distinctly associated with a different cardholder of the plurality of cardholder. Additionally, the computing system may initiate the embossing of identifying information on each credit card of the plurality of credit cards unique to each different cardholder into a discretionary data section of a magnetic strip included on each of the plurality of credit cards. The computing system may receive purchase transaction information associated with the shared credit card account. Further, the computing system may identify a subset of the purchase transaction information as associated with a particular cardholder of the plurality of cardholders. The computing system may also analyze the subset of purchase transaction information to determine potential marketing opportunities. Additionally, the computing system may generate targeted marketing to the particular cardholder based on the analyzed information. Finally, the computing system may provide the generated targeted marketing to the particular cardholder.

In another embodiment, a method for generating marketing targeted to cardholders of credit card accounts is disclosed. The method includes configuring, via at least one processor, a shared credit card account associated with a financial service provider for shared use by a plurality of cardholders, the credit card account including a plurality of credit cards sharing the same primary account number but each being distinctly associated with a different cardholder of the plurality of cardholders. Additionally, the method comprises initiating the embossing of identifying information on each credit card of the plurality of credit cards unique to each different cardholder into a discretionary data section of a magnetic strip included on each of the plurality of credit cards. The method includes receiving purchase transaction information associated with the shared credit card account. Further, the method comprises identifying a subset of the purchase transaction information as associated with a particular cardholder of the plurality of cardholders. The method also includes analyzing the subset of purchase transaction information to determine potential marketing opportunities. Additionally, the method comprises generating, via the at least one processor, targeted marketing to the particular cardholder based on the analyzed information. Finally, the method includes providing the generated targeted marketing to the particular cardholder.

In yet another embodiment, an article of manufacture comprising a credit card associated with a credit card account configured to be shared by two or more cardholders is disclosed. The credit card may further comprise a magnetic strip embossed with at least two tracks of information. Additionally, identifying information unique to a particular one of the two or ore cardholders is embossed into the discretionary data section of a track comprising only numeric and diacritic characters.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed. For example, the methods relating to the disclosed embodiments may be implemented in system environments outside of the exemplary system environments disclosed herein.

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system consistent with disclosed embodiments;

FIGS. 2A-2B illustrate aspects of an exemplary article of manufacture consistent with disclosed embodiments;

FIG. 3 is a flowchart of an exemplary card embossing process consistent with disclosed embodiments;

FIG. 4 is a flowchart of an exemplary merchant purchase transaction reporting process consistent with disclosed embodiments; and

FIG. 5 is a flowchart of an exemplary cardholder marketing process consistent with disclosed embodiments; and

FIG. 6 is a flowchart of an exemplary cardholder marketing analysis process consistent with disclosed embodiments.

### DETAILED DESCRIPTION

Reference will now be made in detail to disclosed embodiments, examples of which are illustrated in the accompanying drawings. Wherever convenient, the same reference numbers will be used throughout the drawings to refer to the same or like parts.

Generally, the disclosed embodiments are directed to systems, methods, and articles of manufacture for determining the purchasing behavior of a particular cardholder on a shared credit card account, and generating targeted marketing directed to the particular cardholder based on purchase transactions completed using the credit card account. Further, steps or processes disclosed herein are not limited to being performed in the order described, but may be performed in any order, and some steps may be omitted, consistent with the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or reconfigured by program code to provide the necessary functionality. The processes disclosed herein may be implemented by a suitable combination of hardware, software, and/or firmware. For example, the disclosed embodiments may implement general purpose machines that may be configured to execute software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer readable media that include program instructions or program code that, when executed by one or more processors, perform one or more computer-implemented operations. For example, the disclosed embodiments may execute high level and/or low level software instructions, such as machine code (e.g., such as that produced by a compiler) and/or high level code that can be executed by a processor using an interpreter.

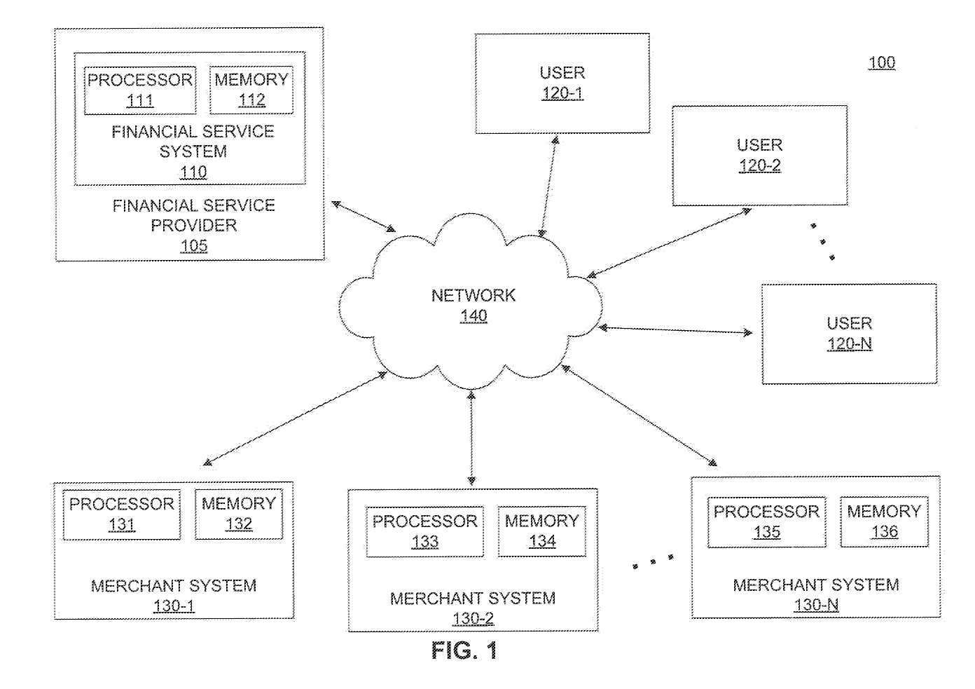

FIG. 1 illustrates an exemplary system 100 consistent with disclosed embodiments. In one aspect, system 100 may include a financial service provider 105, financial service system 110, various users 120-1 through 120-N, various merchant systems 130-1 through 130-N, and network 140.

Financial service provider 105 may be one or more entities that configure, offer, provide, and/or manage financial service accounts, such as credit card accounts, debit card accounts, checking or savings accounts, loyalty accounts, and/or loan accounts. In one aspect, financial service provider 105 may include or be associated with financial service system 110 that may be configured to perform one or more aspects of the disclosed embodiments. In some embodiments, financial service system 110 may receive and process payments from consumers, such as users 120, relating to one or more financial service accounts provided by financial service provider 105 associated with financial service system 110.

Financial service system 110 may include one or more components that perform processes consistent with the disclosed embodiments. For example, financial service system 110 may include one or more computers (e.g., servers, database systems, etc.) configured to execute software instructions programmed to perform aspects of the disclosed embodiments, such as generating financial service accounts and/or loan accounts, maintaining accounts, processing information relating to accounts, etc. Consistent with disclosed embodiments, financial service system 110 may include other components and infrastructure that enable it to perform operations, processes, and services consistent with financial service account providers, such as banking operations, credit card operations, loan operations, etc., including the manufacture of credit cards associated with a credit card account. Consistent with disclosed embodiments, financial service system 110 may be configured to analyze purchase transactions made by individual cardholders of a credit card account, and perform functions to assist one or more merchants in generating targeting marketing to those cardholders.

Users 120-1 through 120-N may be one or more customers or prospective customers of financial service provider 105 and/or merchant systems 130. Users 120 may be an individual, a group of individuals, a business entity, or a group of business entities. Although the description of certain embodiments may refer to an “individual,” the description applies to a group of users or a business entity. In certain aspects, users 120 may be associated with systems (not shown) including one or more computing devices that is associated with (e.g., used by) users 120 to perform computing activities, such as a laptop, desktop computer, tablet device, smart phone, or other handheld or stand-alone devices configured to execute software instructions and communicate with network 140 or other components of system environment 100. For example, users 120 may use a handheld device to communicate with financial service system 110 or merchant systems 130 over the Internet. Reference to users 120 in terms of processes consistent with certain disclosed embodiments may relate to functionalities performed by the users' computing device(s).

Merchant systems 130-1 through 130-N may represent one or more entities that provide goods and/or services that may be purchased by consumers, such as users 120. For example, merchant systems 130 may represent a vendor that offers goods or services users 120 purchase using one or more of the financial service accounts held by the users and provided by financial service system 110 and/or merchant systems 130. Users 120 may purchase goods and/or services from merchant systems 130 directly over normal channels of trade (i.e., a point of sale (POS) purchase), or they may purchase them from merchant systems 130 over network 140 (i.e., telephonically, via POS terminal, “online,” etc. via the Internet).

Merchant systems 130 may each include one or more components that perform processes consistent with the disclosed embodiments. For example, merchant systems 130 may each include one or more computers (e.g., servers, database systems, etc.) that are configured to execute software instructions programmed to perform aspects of the disclosed embodiments and known financial service account processes, such as generating financial service accounts, maintaining such accounts, processing information relating to such accounts, processing and handling transactions relating to sales of goods and/or services, etc. One of ordinary skill in the art would recognize that merchant systems 130 may each include components and infrastructure that enable them to perform operations, processes, and services consistent with merchants, such as providing websites that offer for sale goods and/or services, processing sales transactions of purchases made over the Internet or at POS locations, and communicating with financial service system 110 or other components relating to the transactions.

Consistent with disclosed embodiments, components of system 100, including financial service system 110 and merchant systems 130, may include one or more processors (such as processors 111, 131, 133, or 135) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of financial service system 110 and/or merchant systems 130 to execute multiple processes simultaneously. Other types of processor arrangements could be implemented that provide for the capabilities disclosed herein. Moreover, the processors may represent one or more servers or other computing devices that are associated with financial service system 110 and/or merchant systems 130. For instance, the processors may represent a distributed network of processors configured to operate together over a local or wide area network. Alternatively, the processors may be a processing device configured to execute software instructions that receive and send information, instructions, etc. to/from other processing devices associated with financial service system 110 or other components of system 100. In certain aspects, processors 111, 131, 133 and/or 135 may be configured to execute software instructions stored in memory to perform one or more processes consistent with disclosed embodiments.

Consistent with disclosed embodiments, components of system 100, including financial service system 110 and merchant systems 130, may also include one or more memory devices (such as memories 112, 132, 134, and 136) as shown in exemplary form in FIG. 1. The memory devices may store software instructions that are executed by processors 111, 131, 133, and/or 135, such as instructions associated with one or more applications, network communication processes, operating system software, software instructions relating to the disclosed embodiments, and any other type of application or software known to be executable by processing devices. The memory devices may be volatile or non-volatile, magnetic, semiconductor, tape, optical, removable, nonremovable, or other types of storage devices or tangible computer-readable media. The memory devices may be two or more memory devices distributed over a local or wide area network, or may be a single memory device. In disclosed embodiments, the memory devices may include database systems, such as database storage devices, configured to receive instructions to access, process, and send information stored in the storage devices.

In some embodiments, financial service system 110, users 120, and merchant systems 130 may also include one or more additional components (not shown) that provide communications with other components of the system 100 environment, such as through network 140, or any other suitable communications infrastructure.

Network 140 may be any type of network that facilitates communications and data transfer between components of system environment 100, such as, for example, financial service system 110, users 120, and merchant systems 130. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies. Moreover, any part of network 140 may be implemented through infrastructures or channels of trade to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system 100, any number or combination of components may be implemented without departing from the scope of the disclosed embodiments. For example, different users 120 may interact with one or more merchant systems 130 through network 140 or standard channels of trade, such as face-to-face purchase transactions. In another example, different financial service systems 110 may interact with one or more users 120 (via, e.g., electronic computing devices) and merchant systems 130 through network 140 or standard channels of trade. Additionally, financial service system 110 and merchant systems 130 are not mutually exclusive. For example, in one disclosed embodiment, financial service system 110 and one or more merchant systems 130 may be the same entity. Merchant systems 130 are not mutually exclusive; for example, merchant system 130-1 and merchant system 130-2 may be the same entity, different locations of the same entity, POS aspects and Internet aspects of the same entity, subsidiaries of the same entity, or a parent entity and its subsidiary. Thus, the entities as described are not limited to their discrete descriptions above. Further, where different components of system environment 100 are combined (e.g., merchant system 130-1 and merchant system 130-2, etc.), the computing and processing devices and software executed by these components may be integrated into a local or distributed system.

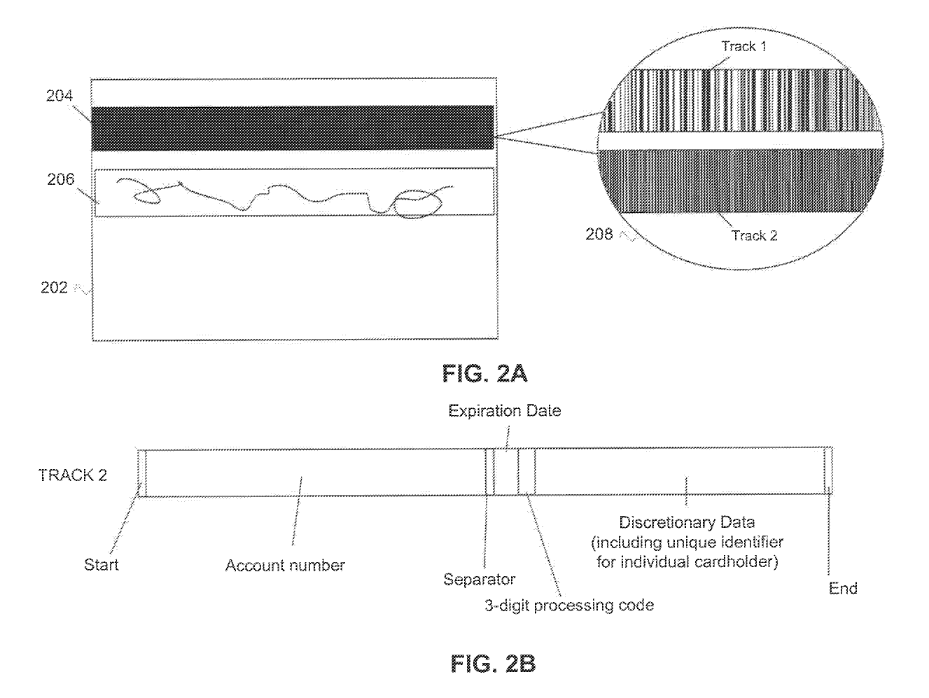

FIGS. 2A-2B illustrate aspects of an exemplary credit card 202, consistent with disclosed embodiments. FIG. 2A is a back view of card 202, illustrating magnetic strip 204 and signature strip 206. Magnetic strip 204 may contain data embossed onto the strip by financial service system 110 in the course of issuing the card to cardholders, such as user 120. Financial service system 110 may emboss the data onto magnetic strip 204 itself, or it may associate itself with another entity to perform the same or similar functions on its behalf. In some embodiments, a merchant system 130 may assist with embossing the data. In other embodiments, the embossing may be completed by a third-party entity outside of the system 100 environment.

Magnetic strip 204 may contain one or more “tracks” of encoded information. As illustrated in inset 208, exemplary magnetic strip 204 illustrated in FIG. 2A contains two tracks of information, Track 1 and Track 2. In some embodiments, magnetic strip 204 may contain only a single track of information. In other embodiments, magnetic strip 204 may contain a plurality of tracks of information. In some embodiments, Track 1 and Track 2 may be embossed with different types of information, illustrated in inset 208 by the different patterns of “written” and “unwritten” tiny bar magnets disposed within the strip. In some embodiments, Track 1 may be configured to contain data representing alphanumeric characters, that is, letters, numbers, and diacritic marks, such as punctuation. Track 2 may contain data representing only numeric and diacritic characters. When present, a third track—Track 3—may also contain data representing only numeric and diacritic characters. In some embodiments, Track 1 may contain data including, but not limited to, the primary account number for the account, the name of the cardholder (i.e., a user 120), the expiration date of the card, one or more service or processing codes used by financial service system 110 and/or merchant systems 130, and a discretionary data section that may include any miscellaneous information desired by financial service provider 105.

FIG. 2B is a diagrammatic illustration of an exemplary Track 2 of magnetic strip 204, consistent with disclosed embodiments. As discussed above, Track 2 may be configured to only be coded with data representing numeric and diacritic characters, as opposed to Track 1, which may be configured to store data representing letters as well. Consequently, Track 2 does not contain the name of the cardholder. In some embodiments, Track 2 may be a different length than Track 1, and may contain fewer characters. In these embodiments, a merchant system 130 may choose only to transmit Track 2 to financial service system 110 when processing a purchase transaction made by user 120 bearing card 202; because Track 2 may be shorter, it may take less time to transmit the data to system 110 and receive authorization. Therefore, in these embodiments, financial service system 110 may not receive the name of the particular user 120 on the configured credit card account that is completing the purchase transaction.

The exemplary Track 2 in FIG. 2B contains single characters at each end of the track for starting and ending the sequence. In some embodiments, a single field separator character may appear in the middle of the track to parse out the account number from the rest of the track. The primary account number may be configured to appear on Track 2, and may serve, in embodiments where a merchant system 130 only transmits Track 2, as the primary identifier of the configured credit card account. Track 2 may also contain a discretionary data section, similar to Track 1. The discretionary data section may contain various codes critical for transaction processing and verification that are unique to the card issuer (such as Visa® or MasterCard®), or to a financial service account provider associated with the card, such as financial service provider 105. For example, the discretionary data section of Track 2 of Visa® cards may contain a “card verification value” (CVV1) for transaction verification, and MasterCard® cards may contain a “card verification code” (CVC1). Debit cards, regardless of issuer, may contain a “card security code” (CSC) in this region.

In some embodiments, the discretionary data section of Track 2 may be further embossed with, among other data, identifying information, such as a numeric sequence that is unique to an individual user 120. Therefore, in this configuration, credit card 202 and magnetic strip 204 enable component members of system environment 100, including financial service system 110, users 120 themselves, or any merchant system 130 to determine the particular user 120 that completed a given purchase transaction, even if all users 120 associated with the credit card account have a common primary account number, such as the familiar 16-digit account number utilized in “account-centric” card frameworks. Methods and systems for incorporating and utilizing this technology will now be discussed in further detail.

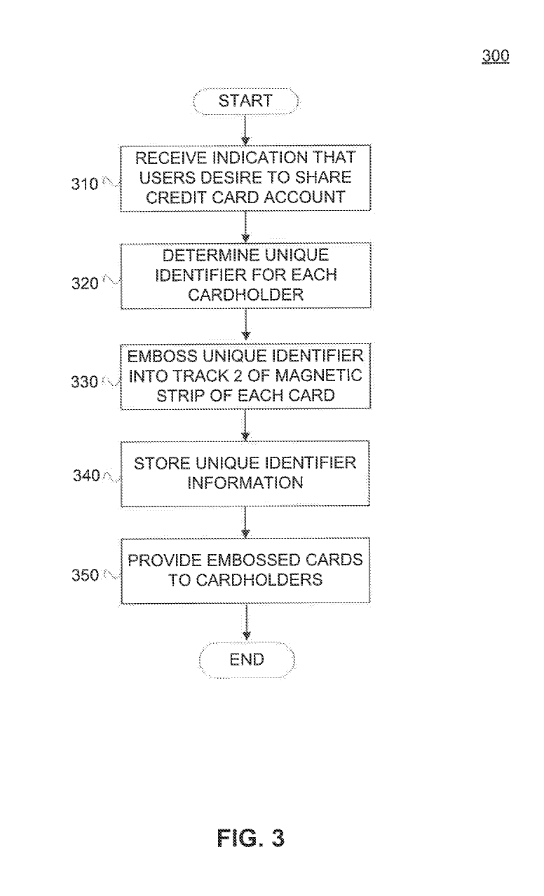

FIG. 3 illustrates an exemplary card embossing process 300, consistent with disclosed embodiments, Card embossing process 300, as well as any or all of the individual steps therein, may be performed by any one or more of financial service system 110 or various merchant systems 130. For exemplary purposes, FIG. 3 is disclosed as being performed by financial service system 110.

Financial service system 110 may receive an indication that two or more users 120 desire to share a common credit card account (Step 310). The credit card account may be an “account-centric system” account as described above, in which all credit cards issued under the account bear the same credit card number. In some embodiments, the credit card account may be a pre-existing account, and may already be associated with one of more of the users 120 seeking to become joint cardholders. In these embodiments, financial service system 110 may configure the existing account to accommodate one or more new users 120 joining the account as cardholders. In other embodiments, financial service system 110 may configure a new credit card account for the prospective joint cardholders.

Financial service system 110 may prompt users 120 for information about the users seeking to become cardholders. The information received may include, for example, name, address, social security or other government ID number, credit history, employment information, financial history, and financial service account information. In some embodiments, the information received may include digital or physical copies of government-issued identification, such as a driver's license, social security card, passport, etc. In some embodiments, the received information may include proof of income, and may be received in the form of a digital or physical copy of a pay stub, paycheck, human resources document, tax return, etc. In some embodiments, financial service system 110 may require and receive personal or business references from users 120. Financial service system 110, however, may prompt for more or less information, based on characteristics of users 120, geographical location, legal restrictions, or any other concern or consideration relating to the business of financial service provider 105. Financial service system 110 may additionally generate or receive a risk assessment, or other similar creditworthiness analysis, associated with users 120 using the received information. In some embodiments, financial service system 110 may access additional information associated with users 120 on external servers via network 140, such as those associated with well-known credit bureaus.

Financial service system 110 may determine a unique identifier for each cardholder (i.e., user 120) associated with the configured credit card account (Step 320). In some embodiments, the unique identifier may be a numeric sequence unique to each individual on the account. The numeric sequence may be any number of digits configured to fit within one or more tracks of the magnetic strip of credit card 202 (for example, 40 digits or less). In some embodiments, the unique identifier may be a numeric sequence previously assigned to the cardholder by financial service system 110, such as a cardholder sequence number or enterprise number. The sequence may be provided to the cardholder, or alternatively, it may be maintained securely internally by financial service system 110. In some embodiments, the unique identifier may be an embosser sequence number. The unique identifier is preferably a numeric sequence so that it can later be embossed onto any and all tracks 1-3 of a typical magnetic strip 204, including tracks such as Track 2 that may be configured to only accept numeric or diacritic characters.

Financial service system 110 may emboss the individual unique identifiers for each distinct cardholder on the configured credit card account onto the magnetic strip 204 of the credit card 202 configured for the distinct cardholder (Step 330). Specifically, financial service system 110 may emboss the unique identifier into the discretionary data section of one or more of Tracks 1 or 2 of magnetic strip 204 of credit card 202. In some embodiments, financial service system 110 may emboss the unique identifier into the discretionary data section of Track 2 of the magnetic strip. In some embodiments, magnetic strip 204 may include a third track, and if so configured, the unique identifier may be embossed onto Track 3 as well. Financial service system 110 may emboss the unique identifier onto any or all of the tracks; for example, a combination of Tracks 2 and 3, Track 2 only, etc. Financial service system 110 may use any suitable card-writing or embossing apparatus and method to emboss the unique identifier onto the cards.

Financial service system 110 may store the embossed unique identifier information (Step 340). In some embodiments, the information may be stored in internal memory devices associated with financial service system 110, such as memory 112. In other embodiments, the information may be stored on a remote server or in a remote memory device accessible by financial service system 110 over network 140. The unique identifier information may be stored with various other types of information to assist in analysis, including but not limited to the name and address of the corresponding user 120 (e.g. user 120-1, user 120-2, etc.), demographic information about the corresponding cardholder, financial information, past spending habits, payment history, etc. Financial service system 110 may be configured to store more or less information depending on the particular configured financial service account. The information may be stored in the event it becomes necessary to issue a new credit card 202, such as in the case of the card being stolen, lost, deactivated, or expired. The unique identifier may further be stored and retrieved for association with other financial service accounts associated with financial service provider 105, including additional credit card accounts. After storing the information, financial service system 110 may provide the embossed cards 202 to the corresponding users 120 (Step 350). The cards 202 may be provided by postal mail, or in person at a physical location associated with financial service provider 105. In some embodiments, users 120 may each be provided with multiple copies of card 202. In some embodiments, financial service system 110 may be configured to assist users 120 with activation of the cards. The activation may occur via telephonic means, via electronic means, such as the Internet, over network 140, or may occur in person.

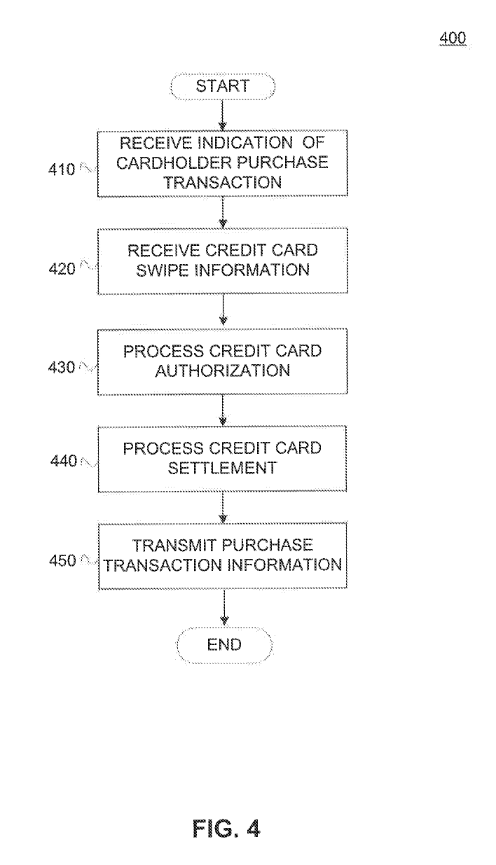

FIG. 4 illustrates a flowchart of an exemplary merchant purchase transaction reporting process 400 consistent with certain disclosed embodiments. Merchant purchase transaction reporting process 400, as well as any or all of the individual steps therein, may be performed by any one or more of financial service system 110 or any of merchant systems 130. For exemplary purposes, FIG. 4 is disclosed as being performed by merchant system 130-1.

Merchant system 130-1 may receive an indication at a point-of-sale that a user 120, such as user 120-1, desires to complete a purchase transaction using a credit card associated with a financial service account (Step 410). In one aspect, the card may be card 202 including magnetic strip 204, as illustrated in FIGS. 2A-2B, configured to include a unique identifier within the Track 2 discretionary data to identify the bearer as user 120-1. As discussed above, card 202 may be associated with a financial service account configured for user 120-1 by financial service system 110. In some embodiments, card 202 may additionally be associated with merchant system 130-1.

Upon determining the goods or services comprising the purchase transaction, and the cost of said goods or services, merchant system 130-1 may swipe card 202 into its system, and may receive credit card swipe information (Step 420). In other embodiments, merchant system 130-1 may receive the card information via other suitable data exchange methods known to those of skill in the art, such as card insertion, near field communication (NFC), etc. In one aspect, the received card swipe information may include any or all of the data embossed onto any or all of Tracks 1, 2, or if so configured, Track 3. In some embodiments, merchant system 130-1 may associate the received card swipe information with information associated with the purchase transaction, such as a merchant category code, that provides information about the general type of purchase within the authorization message.

In some embodiments, merchant system 130-1 may process a credit card authorization for the purchase transaction associated with user 120-1 and card 202 (Step 430). An authorization may be processed if merchant system 130-1 is configured to accept additional payments on the same purchase transaction before completing and closing the transaction. Examples of such configurations may include, but are not limited to, transactions that may be associated with an added gratuity, transactions at the pump at a gas station, or any other transaction that may be associated with an additional outlay of funds after the initial card swipe.

Merchant system 130-1 may process a credit card settlement for the purchase transaction associated with user 120-1 and card 202 (Step 440). In embodiments described above where an authorization is processed for the transaction, the settlement may include any additional amount added to the amount presented for the initial authorization. In other embodiments, where authorizations are not applicable, the settlement processed in Step 440 may be the first time the purchase transaction is processed by merchant system 130-1. For example, merchant system 130-1 may check a government-issued identification card to confirm that the person bearing card 202 is indeed the user 120-1 for whom the card was embossed. In some embodiments, user 120-1 may sign a purchase agreement indicating that they acknowledge the transaction and are committed to paying for the purchase using funds associated with card 202 and the financial service account configured by financial service system 110. Merchant system 130-1 may perform additional processing steps controlled by processor 131, such as providing user 120-1 with a receipt of the transaction, storing information relating to the transaction in memory 132, or any other steps required for completing and closing a purchase transaction typical for merchant system 130-1 and/or financial service system 110.

Merchant system 130-1 may also execute software instructions (via, e.g., processor 131 and memory 132) to transmit the purchase transaction information described above to financial service system 110 (Step 450). In one embodiment, merchant system 130-1 may provide the information to financial service system 110 via network 140, an external database, or directly via other communication mechanisms. In some embodiments, merchant system 130-1 may transmit only information associated with Track 2 of magnetic strip 204. In other embodiments, information associated with both Tracks 1 and 2 may be transmitted. Merchant system 130-1 may provide the transaction information on a transaction-by-transaction basis immediately after settling the transaction, or may provide summary information on a repeating basis, for example, hourly, daily, weekly, monthly, quarterly, yearly, or on a fiscal year basis. Upon receiving the purchase transaction information from merchant system 130-1, financial service system 110 may store the information, for example, in memory 112.

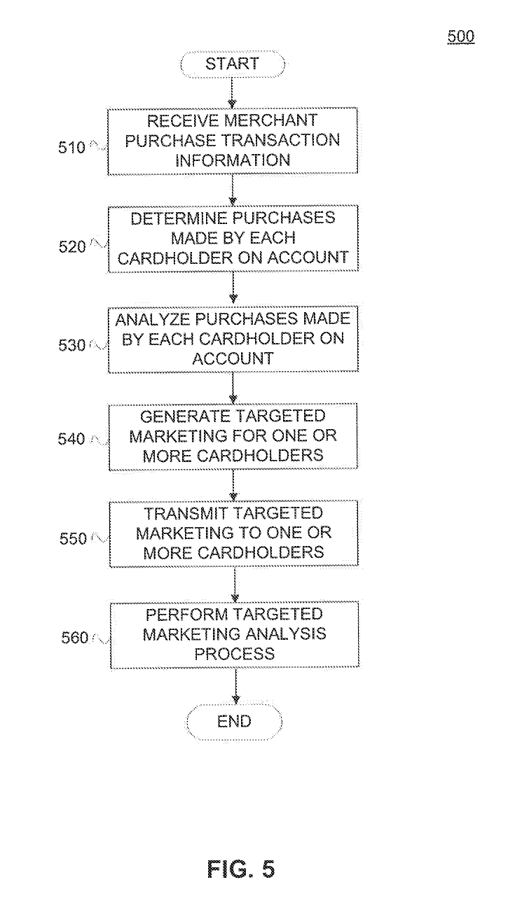

FIG. 5 illustrates a flowchart of an exemplary cardholder marketing process 500 consistent with certain disclosed embodiments. Cardholder marketing process 500, as well as any or all of the individual steps therein, may be performed by any one or more of financial service system 110 or merchant system 130-1. For exemplary purposes, FIG. 5 is disclosed as being performed by financial service system 110.

Financial service system 110 may receive merchant purchase transaction information, such as the transmitted information described above in association with Step 450 of process 400 (Step 510). As discussed above, the purchase transaction information may include various details about previous purchase transactions, such as identifying information about the merchant systems 130 associated with the sale, the date and time of the purchase transactions, the location (POS or remote) where the purchase transaction was made, the currency value of the purchase transaction, the item or items purchased in the purchase transaction, etc. This list of information contained in the purchase transaction history is not intended to be limiting to the disclosed embodiments and financial service system 110 may receive and review more or less information in a given instance.

In some embodiments, the received purchase transaction information may categorize the purchase transactions according to the user 120 who completed each of the transactions, as determined by the unique identifying information embossed into Track 2 of magnetic stripe 204. In these embodiments, financial service system 110 may determine all purchase transactions made by one or more of the users 120 associated with the configured financial service account (Step 520). Financial service system 110 may further analyze the purchases determined to be associated with each user 120 using the Track 2 embossed data (Step 530). In some embodiments, analysis may include information about the merchant system 130 associated with the transaction. Merchant-related information may include a broad category of merchant, such as “restaurant,” or “home improvement,” that may be suggested by a third-party source such as, for example, a merchant classification code (MCC) associated with each of the purchase transactions. The merchant-related information may also include a specific merchant, such as a specific retailer or brand store. Further, the information may include geographic or temporal information about the merchant and/or purchase, and in some embodiments, the frequency of transactions commenced at that location. As one example of such merchant information, financial service system 110 may determine that user 120-1 made three purchase transactions at City Grocery Store located in City X during the month of January.

Additional analyses of purchase transaction information by financial service system 110 may focus on the items purchased by user 120. As non-limiting examples, financial service system 110 may determine the identity of items purchased, their number, their price, the brand of item, and the discount, if any, that the customer received on the item. Carrying forward the example discussed above, financial service system 110 may determine that while shopping at City Grocery Store, user 120-1 purchased fifteen rolls of Mid-Market Brand Toilet Paper. The information described here is intended to be exemplary only. Financial service system 110 may perform multiple levels of analysis to determine any data or patterns of data associated with purchase transactions made by a user 120 using a credit card 202 associated with a configured financial service account.

The disclosed embodiments enable financial service system 110, and potentially, merchant systems 130, to gain critical insight into purchasing habits of individual cardholders who share a credit card account. Previously, if a merchant system 130-1 transmitted only Track 2 magnetic strip data when processing a purchase transaction, it would be completely unclear in an “account-centric” framework (the most common in the industry) which of several cardholders on a shared account made a particular purchase. Names of individual cardholders would only be present if the merchant system expended the extra time and effort to transmit either Track 1 magnetic strip data alone, or both Track 1 and Track 2 data. In today's retail environment, many merchant systems 130 process the transactions using the numeric Track 2 data only, due to the track (and thus the processing time) being shorter. Consequently, only the primary account number would be processed through the system and received by financial services system 110. Thus it would be unknown whether user 120-1, for example, a husband, or user 120-2, his wife, actually completed a given purchase transaction. With this information now available in an “account-centric” framework using the embossing process described above, financial service system 110 and merchant systems 130 may be capable of capitalizing on a huge influx of new information about the purchasing habits of individual users 120 that was not previously available.

Financial service system 110, in association with one or more merchant systems 130, may utilize information derived from the purchase transaction analysis of individual user 120 cardholders to generate targeted marketing directed to one or more users 120 (Step 540). The targeted marketing may be generated according to any number of individualized marketing schemes known to those of ordinary skill based on the information made available by embossed credit cards 202. The marketing may be generated for any number of users 120 for which financial service system 110 has configured financial service accounts associated with embossed credit cards 202. The marketing may be generated for as few as one user 120, up to and including all users 120 for which financial service system 110 has configured financial service accounts. The generated targeted marketing may include a wide range of advertising and incentives relevant to the goals of a particular merchant system 130, such as merchant system 130-1, and the nature of its business. For example, based on information analyzed from the purchase transaction data, financial service system 110 may determine that a given cardholder, such as user 120-1, buys a great deal of a certain brand of product at a point-of-sale associated with merchant system 130-1. In response, financial service system 110 may assist merchant system 130-1 in generating a targeted communication to user 120-1 to encourage loyalty and business flow to merchant system 130-1.

For example, financial service system 110 may assist merchant system 130-1 in generating targeted advertising for the items in its inventory that correspond with the items frequently purchased by user 120-1. In some embodiments, merchant system 130-1 may generate a coupon for user 120-1 directed towards these items, or in conjunction with financial service system 110, may issue user(s) 120 a card-linked offer linked to credit card 202 that may show up at the point-of-sale the next time user 120-1 completes a purchase transaction with merchant system 130-1. In other embodiments, financial service system 110 and merchant system 130-1 may use the analyzed information to suggest other products that user 120-1 might like, such as a slightly higher quality brand of the same product that user 120-1 is seen to frequently purchase. As above, the generated targeted marketing may then include an incentive to try the new item, such as a coupon, card-linked offer, free item, discount, etc.

In some embodiments, financial service system 110 may enter an agreement with one or more merchant systems 130 to provide the analyzed data for competitive marketing purposes. For example, the received purchase transaction information may reveal that user 120-1 shops for certain items frequently at a point-of-sale associated with merchant system 130-1. Financial service system 110 may assist merchant system 130-2, a competing entity, to generate targeted marketing in an attempt to entice user 120-1 to purchase items at its stores instead. Other targeted marketing is also possible based on the data generated by the disclosed embodiments. For example, the received purchase transaction information may indicate that for a multiple user account, such as a corporate credit card account, certain users 120 are purchasing items for the company from one merchant system 130, while other users 120 are frequenting a different merchant system 130. Financial service system 130 may generate targeted marketing for one (or in some aspects, both) of the merchant systems 130 to attempt to influence decision makers at the business associated with the corporate card to consolidate the shopping with that particular merchant. It is to be understood that these targeting marketing practices are exemplary, and the list is not intended to be limiting. One skilled in the art may conceive of a multitude of possible targeted marketing opportunities that financial service system 110 may generate for one or more merchant systems 130 using individual customer data made available by embossed credit cards.

Financial service system 110 may transmit the generated targeted marketing to the targeted one or more users 120 (Step 550). In some embodiments, the targeted marketing may be in hard copy and may be transmitted to a user 120 by postal mail or during a purchase in person at a point of sale. In other embodiments, the targeted marketing may be digital and provided to user 120 over network 140. For example, the marketing may be sent to user 120 as an electronic mail message or as an SMS text message. Multiple methods of providing the targeted marketing to user 120 are within the scope of the disclosed embodiments, including multiple methods of providing the same targeted marketing to the same targeted user 120. Financial service system 110 may also perform a targeted marketing analysis process (Step 560), which will now be discussed in detail.

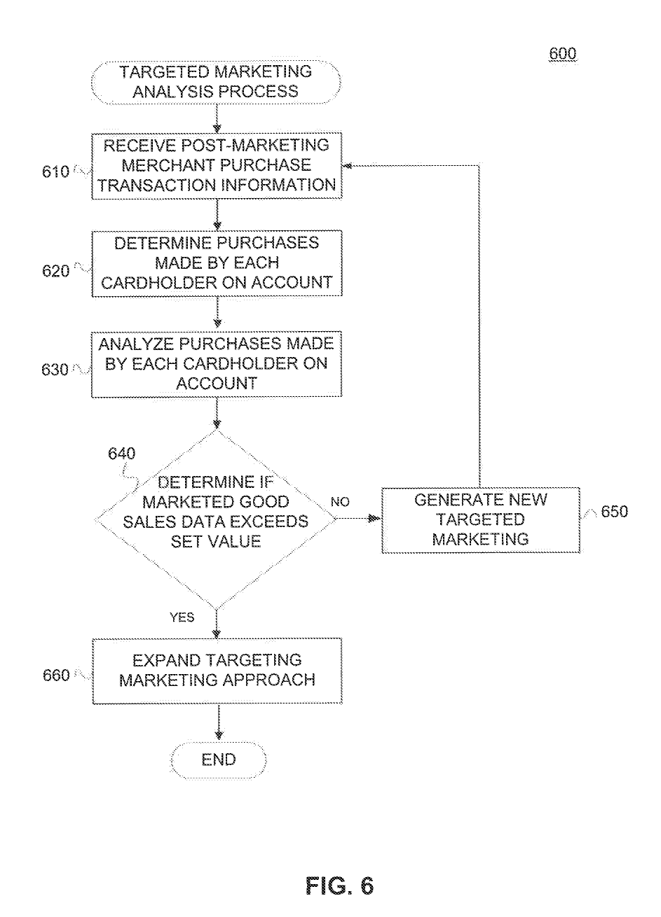

FIG. 6 illustrates a flowchart of an exemplary targeted marketing analysis process 600 consistent with certain disclosed embodiments. Targeted marketing analysis process 600, as well as any or all of the individual steps therein, may be performed by any one or more of financial service system 110 or merchant system 130-1. For exemplary purposes, FIG. 6 is disclosed as being performed by financial service system 110.

Subsequent to transmitting the generated targeted marketing of process 500 to a particular user 120, financial service system 110 may receive post-marketing merchant purchase transaction information (Step 610). According to some embodiments, the information may be received substantially as described above in association with Step 510. Financial service system 110 may receive the updated purchase transaction information at one or more predetermined points in time after transmission of the targeted marketing. For example, financial service system 110 may receive the updated information hourly, daily, weekly, monthly, quarterly, yearly, or on a fiscal year basis after providing the targeted marketing to the particular user 120. The information may be sampled one time at a particular desired time, or financial service system 110 may repeatedly access and receive the data at the behest of the merchant system 130 associated with the targeted marketing. In some embodiments, if the targeted marketing comprises an incentive offer, such as a coupon or a card-linked offer, financial service system 110 may be configured to receive the purchase transaction information when the incentive offer is redeemed by user 120-1. In other embodiments, financial service system 110 may be configured to receive the transaction information as monthly reports. In some embodiments, financial service system 110 may be configured to receive the reports when a certain quantity of one or more items featured in the targeted marketing is sold, or when a certain dollar value of one or more items featured in the targeted marketing is sold.

As discussed above, the improved embossing methods of the disclosed embodiments enable financial service system 110 to determine purchases made by a particular user 120 on a shared account (Step 620). This process may occur substantially as described previously in association with Step 520. Based on the unique identifying numerical sequence that may be embossed onto Track 2 of magnetic stripe 204, financial service system 110 may be able to determine individual purchase transactions performed by the particular users sharing an account, such as users 120-1 and 120-2. Further, financial system 110 may be able to determine additional information associated with each purchase transaction.

Financial service system 110 may analyze the purchase transactions made by the particular user 120 targeted in the targeted marketing effort of process 500, such as user 120-1 (Step 630). As discussed above in association with Step 530, analyzed information may include, but not be limited to, particular items purchased, such as one or more items advertised in the targeted marketing, particular merchants, such as the merchant system 130 associated with the marketing, and other financial, geographic, and demographic information. Financial service system 110 may determine that purchase transactions are linked to the targeted marketing effort in a variety of ways. For example, financial service system may detect that a code linked to an incentive offer was redeemed, such as a barcode on a printed coupon, or a unique coupon code generated for user 120-1 subsequently used in an online transaction. In other embodiments, if the targeted marketing was provided by electronic mail, financial service system 110 may be configured to detect that a dedicated link contained in the electronic mail message was followed and a product was subsequently purchased. Financial service system 110 may be further configured to parse the purchase transaction data as part of the analysis to identify specific product SKU numbers or specific MCC codes.

Based on the analyzed purchase transaction information, financial service system 110 may determine if sales data associated with user 120-1 for a particular good or service advertised in the targeted marketing or if sales for the subject merchant system 130 as a whole meet or exceed a set value forecast for the sales data (Step 640). If the sales data does not meet or exceed the set value (Step 550: NO), targeted marketing analysis process 600 may proceed to Step 650, wherein financial service system 110 and merchant system 130-1 may generate a new targeted marketing approach. In some embodiments, financial service system 110 may determine that a preferred approach is to repeat the previous targeted marketing. In other embodiments, financial service system 110 may opt to enact a different set of targeted marketing objectives, such as marketing geared towards promoting a different product or different incentives to the customer. Subsequently, financial service system 110 may sample purchase transactions associated with the particular user 120 at future desired points in time and re-evaluate the success of the new targeted marketing approach by repeating Steps 610-640.

If the sales data does meet or exceed the set value (Step 640: YES), then financial service system 110 and merchant system 130-1 may choose to expand the successful targeted marketing approach (Step 660). In some embodiments, financial service system 110 may generate additional marketing and incentives geared towards the originally targeted user 120, such as user 120-1. In other embodiments, financial service system 110 may generate targeted marketing similar to the successful marketing approach to target other users sharing the same credit card account as the successfully targeted user 120-1, such as user 120-2. In still other embodiments, financial service system 110 may use associated geographic and demographic data to target other users 120 who do not share a credit card account with user 120-1, but share similar geographic and demographic characteristics. For example, financial service system 110 and merchant system 130-1 may choose to expand the successful targeted marketing approach by using geographic and demographic data to target users 120 in a different geographic location but in the same age group and life stage (e.g., gender, marital status, number of children, etc.) If desired, financial service system 110 and merchant system 130-1 may periodically repeat analysis Steps 610-640 to further monitor the success of these ongoing, expanded marketing campaigns.

Other features and functionalities of the described embodiments are possible. For example, the processes of FIGS. 3-6 are not limited to the sequences described above. Variations of these sequences, such as the removal and/or the addition of other process steps may be implemented without departing from the spirit and scope of the disclosed embodiments.

Additionally, any financial institution that provides credit card accounts to customers may employ systems, methods, and articles of manufacture consistent with certain principles related to the disclosed embodiments. In addition, any merchant may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

What is claimed is:

1. A system for generating marketing targeted to cardholders of credit card accounts, comprising:
a memory storing instructions; and
a processor configured to execute the instructions to:
configure a shared credit card account associated with a financial service provider for shared use by a plurality of cardholders, the credit card account including a plurality of credit cards sharing the same primary account number but each being distinctly associated with a different cardholder of the plurality of cardholders;
initiate the embossing of identifying information on each credit card of the plurality of credit cards unique to each different cardholder into a discretionary data section of a magnetic strip included on each of the plurality of credit cards;
receive purchase transaction information associated with the shared credit card account;
identify a subset of the purchase transaction information as associated with a particular cardholder of the plurality of cardholders;
analyze the subset of purchase transaction information to determine potential marketing opportunities;
generate targeted marketing to the particular cardholder based on the analyzed information; and
provide the generated targeted marketing to the particular cardholder.

2. The system of claim 1, wherein the processor is further configured to execute the instructions to determine whether sales of one of a plurality of products or services associated with the targeted marketing to the particular cardholder have increased.

3. The system of claim 2, wherein the targeted marketing is altered based on whether the sales have increased.

4. The system of claim 1, wherein identifying a subset of the purchase transaction information associated with the particular cardholder comprises determining the subset of purchase transactions associated with the identifying information unique to each different cardholder.

5. The system of claim 1, wherein analyzing the purchase transaction information includes at least one of: determining particular products associated with one or more purchase transactions, determining one or more merchants associated with one or more purchase transactions, or determining the sale price of the particular products associated with the one or more purchase transactions.

6. The system of claim 1, wherein the targeted marketing is at least one of a coupon, discount code, or card-linked offer provided to the particular cardholder based on the analyzed purchase transaction information.

7. The system of claim 1, wherein the magnetic strip comprises a plurality of tracks and the track embossed with the identifying information comprises only numeric and diacritic characters.

8. The system of claim 6, wherein the coupon, discount code, or card-linked offer is provided to the particular cardholder at a point of sale during a future purchase transaction.

9. The system of claim 1, wherein the targeted marketing is provided to one or more other cardholders not associated with the shared credit card account based on the analyzed purchase transaction.

10. A method for generating marketing targeted to cardholders of credit card accounts, comprising:
configuring, via at least one processor, a shared credit card account associated with a financial service provider for shared use by a plurality of cardholders, the credit card account including a plurality of credit cards sharing the same primary account number but each being distinctly associated with a different cardholder of the plurality of cardholders;
initiating the embossing of identifying information on each credit card of the plurality of credit cards unique to each different cardholder into a discretionary data section of a magnetic strip included on each of the plurality of credit cards;
receiving purchase transaction information associated with the shared credit card account;
identifying a subset of the purchase transaction information as associated with a particular cardholder of the plurality of cardholders;
analyzing the subset of purchase transaction information to determine potential marketing opportunities;
generating, via the at least one processor, targeted marketing to the particular cardholder based on the analyzed information; and
providing the generated targeted marketing to the particular cardholder.

11. The method of claim 10, further comprising determining whether sales of one of a plurality of products or services associated with the targeted marketing to the particular cardholder have increased.

12. The method of claim 11, wherein the targeted marketing is altered based on whether the sales have increased.

13. The method of claim 10, wherein identifying a subset of the purchase transaction information associated with the particular cardholder comprises determining the subset of purchase transactions associated with the identifying information unique to each different cardholder.

14. The method of claim 10, wherein analyzing the purchase transaction information includes at least one of: determining particular products associated with one or more purchase transactions, determining one or more merchants associated with one or more purchase transactions, or determining the sale price of the particular products associated with one or more purchase transactions.

15. The method of claim 10, wherein the targeted marketing is at least one of a coupon, discount code, or card-linked offer provided to the particular cardholder based on the analyzed purchase transaction information.

16. The method of claim 10, wherein the magnetic strip comprises a plurality of tracks and the track embossed with the identifying information comprises only numeric and diacritic characters.

17. The method of claim 15, wherein the coupon, discount code, or card-linked offer is provided to the particular cardholder at a point of sale during a future purchase transaction.

18. The method of claim 10, wherein the targeted marketing is provided to one or more other cardholders not associated with the shared credit card account based on the analyzed purchase transaction.

19. An article of manufacture, comprising:
a credit card associated with a credit card account configured to be shared by two or more cardholders,
wherein the credit card further comprises a magnetic strip embossed with at least two tracks of information, and
wherein identifying information unique to a particular one of the two or more cardholders is embossed into the discretionary data section of a track comprising only numeric and diacritic characters.

20. The article of manufacture of claim 19, wherein the identifying information comprises a numeric sequence uniquely associated with the particular cardholder by the financial service provider.
